(19) United States
(12) Patent Application Publication
(10) Pub. No.: US 2004/0200126 A1
(43) Pub. Date: Oct. 14, 2004

(54) Breakaway connector

(76) Inventor: Robert Ames, Rockland, ME (US)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/813,049

(22) Filed: Mar. 31, 2004

Related U.S. Application Data
(60) Provisional application No. 60/458,429, filed on Mar. 31, 2003.

(51) Int. Cl. A01K 91/00

(52) U.S. Cl. 43/43.12

(57) ABSTRACT

A method of establishing a fishing line with a breakaway feature includes connecting a first end of a rope to underwater gear and attaching its second end to a breakaway connector without using or having to form a noose or a closed loop in the second end of the rope. The second end is inserted through a passage of the breakaway connector on one side of a breakaway element disposed in the passage, and passed back on the opposite side. When either end of the rope is pulled, a bent section of the rope comes to rest on the breakaway element. Further pulling the rope applies a load on the breakaway element which will break when the load reaches a predetermined level, allowing the rope to slip through the passage. Thus, the rope is completely released, without carrying at the second end thereof a noose or a closed loop which might be caught, e.g., in the mouth of a marine mammal.

The present application claims priority from, Provisional Application No. 60/458,429, filed Mar. 31, 2003, the disclosure of which is hereby incorporated by reference herein in its entirety.

### TECHNICAL FIELD

The present invention generally relates to a breakable link or connector, for use in a fishing line, which breaks upon application of a load in excess of a terminal material failure of the breakable link. More particularly, the present invention relates to a breakable link configured to reliably break when a large animal such as a cetacean is entangled in the fishing line equipped with the breakable link, thereby releasing the animal without harm or death, or only with minimal injury.

### BACKGROUND OF THE INVENTION

It has been known in the fishing industry that whales and other cetaceans may be entangled in various underwater obstructions, such as fixed fishing gear, crab traps, sink gillnets, lobster trawls, and the like. More particularly, these animals may become entangled with buoy lines connecting a surface buoy at the water surface level to underwater gear located at the sea bottom. If the entanglement happens, the animal is likely to attempt to tow the surface buoy, buoy line and the underwater gear associated with the surface buoy. The heavy weight of the underwater gear, as well as the drag resistance from movement of the gear through the water, limits the ability of the animal to maneuver and/or resurface for air. The size and strength of the animal lets it continue for a limited time but under great strain and stress. In some cases, the animal may be severely injured and/or stressed which can lead to death of the animal.

Certain federal legislation, such as the 1995 Marine Mammal Protection Act, has been passed to impose strict standards on the fishing industry to protect marine mammals from death or injury caused by entanglement with underwater fishing lines. A solution has been proposed to timely disconnect the underwater gear from the surface buoy, thereby releasing the entangled whale/cetacean from the buoy line attaching the two devices. In order to carry out this method, there is a need for a device which, when incorporated in a fishing line, will reliably break to separate the buoy from the gear and free the entangled animal.

A suitable device has been disclosed in U.S. patent application Ser. No. 10/042,378 which was filed in the name of Applicant of the instant application and the claims of which were allowed by the USPTO. The entirety of U.S. patent application Ser. No. 10/042,378 is incorporated herein by reference.

The device disclosed in U.S. patent application Ser. No. 10/042,378 includes two loop-shaped connecting portions and a join portion connecting the loop-shaped connecting portions. In use, each of the connecting portions is attached to one of a surface buoy and underwater gear via a length of rope or cable. One of the connecting portions has a full-size portion joined to the join portion and a reduced-size or weakened portion. The weakened portion has a cross-sectional dimension smaller than that of the full-size portion, the connecting portion and the join portion. Accordingly, the weakened portion is expected to be the weakest point of the breakable link and will rupture first when an appropriate load or stress is applied thereto.

A rope or cable is attached to the link using various types of knots, splices, braids, hitches etc. This is demonstrated in FIG. 17. It is common practice for a fisherman to quickly connect a breakable link 1720 to an external device, such as a buoy or underwater gear, using a rope 1750 having a loop 1751 incorporated therein by way of a splice 1752. A “hitch” is thus formed as can be seen at 1792 in FIG. 17. Alternatively, a rope 1760 can be tied to the breakable loop of the breakaway link by forming a noose, at 1770, or a closed loop as depicted in FIG. 17. In either way, when the breakable loop breaks, e.g., as a result of entanglement of a whale in the fishing line, rope 1750 or 1760 is released. However, noose 1770 or loop 1751 remains at the free end of rope 1750 or 1760. This noose or loop may still be caught in the mouth of the whale, and consequently, the whale may not be freed from the rope, one end of which is still attached to underwater gear, e.g., a heavy lobster trap. Thus, although, the breakable link breaks, the whale may still be entangled in the fishing line and, as a result, may not be able to resurface for air.

Therefore, there is still a need for a device which not only reliably breaks under a predetermined stress but also allows a rope or cable to be attached thereto without using or having to form a noose or a closed loop in the rope.

### SUMMARY OF THE INVENTION

It is, therefore, an object of the present invention to provide a light weighted and inexpensive breakable link which allows a rope or cable to be attached thereto without using or having to form a noose or a closed loop in the rope.

It is another object of the present invention to provide a breakable link which, in practice, reliably breaks upon application of an appropriate load regardless of how, e.g., under what angle, the load is applied to the breakable link.

It is a further object of the present invention to provide a breakable link configuration which facilitates calibration of the breakable link to various load requirements.

These and other objects of the present invention are achieved by a method of establishing a breakaway connection in a fishing line, comprising the steps of connecting one end of a rope to underwater gear, and attaching an opposite end of the rope to a breakaway connector without using or having to form a noose or a closed loop in the opposite end of the rope. In accordance with the present invention, it is desirable that the rope is released without any portion of the breakable link staying on the rope.

In accordance with an aspect of the present invention, a breakaway connector is provided for use in the method of the invention. The breakaway connector comprises first connecting means for connecting with an external device, and second connecting means for maintaining a length of rope in a bent state and for holding the rope until a load applied to the rope reaches a predetermined level at which the second connecting means completely release the rope. The second connecting means comprise a breakaway element that will fail under the load of the predetermined level to release the rope.

In accordance with another aspect of the present invention, the breakaway connector comprises a body having a through hole, and a web extending transversely of the through hole and dividing the through hole into first and second channels. In use, an end of the rope is inserted through the through hole on one side of the web and passed back on the opposite side. Preferably, a material failure load of the web is smaller than a material failure load of the body.

In an embodiment, the web has a notch extending axially of the through hole and being positioned in a central region of the web for accommodating, at least partially, a bent section of a rope being inserted in the first and second channels to pass around the web. The web also has indentations at which the web fails under stress.

In another embodiment, the through hole includes, in an axial direction thereof, first and second sections angled with respect to each other with the web being positioned only within the first section.

In a further embodiment, the body is a ring-shaped body that extends circumferentially for less than 360 degrees and has first and second end portions circumferentially spaced from each other to define a loop for connection to an external device and a slot extending between the spaced first and second end portions from an outer circumferential surface of the body into the loop. The through hole may or may not open into the slot and/or the loop.

In accordance with a further aspect of the present invention, a breakaway connection is provided for implementing the method of the present invention. The breakaway connection comprises a rope and a breakaway connector. The breakaway connector comprises a body having a passage for the rope and a transverse web positioned in the passage. A length of the rope being received in the passage includes first and second sections on opposite sides of the web and a bent section which connects the first and second sections and comes to rest on the web when one of the first and second sections of the rope is pulled. The web defines a weakened region of the breakaway connector which will fail to completely release the rope from the breakaway connector when a load applied to the web via the bent section of the rope reaches a predetermined level. The friction between the rope and at least one of the passage and the web is sufficient to hold the rope against slipping within the passage until the weakened region fails.

In an embodiment, the rope may be formed with a weakened portion which fails before the web.

In another embodiment, the connection further comprises underwater gear connected to an end portion of the first section of the rope. When the first section of the rope is pulled towards the underwater gear, the first section of the rope presses the second section of the rope against a wall of the breakaway connector, thereby preventing the second section of the rope from slipping within the passage.

In a further embodiment, the connection also includes a swivel which may be a breakable swivel.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout, and wherein:

FIG. 1 is a front view of a breakaway connector in accordance with an embodiment of the present invention;

FIGS. 2A and 2B are cross sections taken along line II-II in FIG. 1 in accordance with various embodiments of the present invention;

FIGS. 3A and 3B are side views, as seen in the direction of arrows III-III, of the breakway connector in FIG. 1 in accordance with various embodiments of the present on;

FIG. 4 is a cross section taken along line IV-IV in FIG. 1; FIGS. 5A-5D show various embodiments of the breakaway connector of the present invention;

FIGS. 6A-6D show the breakaway connectors of FIGS. 5A-5D, respectively, with ropes attached thereto;

FIGS. 7A and 7B are plan views of breakable swivels which can be used in addition or as an alternative to the breakaway connector of the present invention;

FIGS. 8A and 8B show alternative ways of attaching a length of rope to the breakaway connector of the present invention;

FIG. 9 is a side view similar to FIGS. 3A and 3B showing a preferred embodiment of the present invention;

FIGS. 10A and 10B are cross sections taken along line X-X in FIG. 3A in accordance with various embodiments of the present invention;

FIGS. 11-15 further show various embodiments of the breakaway connector of the present invention;

FIG. 16 shows the breakaway connector of the present invention being incorporated in a fishing line;

FIG. 17 shows a breakable swivel being attached to a rope using a noose or a closed loop.

### BEST MODE FOR CARRYING OUT THE INVENTION

A breakaway connector and a fishing line incorporating the breakaway connector in accordance with the present invention are described. In the following detailed description, for purposes of explanation, numerous specific details are set forth in order to provide a thorough understanding of the present invention. It will be apparent, however, that the present invention may be practiced without these specific details. In other instances, well-known structures and devices are schematically shown in order to simplify the drawing.

Referring now to FIG. 16, a fishing line 1610 is shown. Fishing line 1610 comprises a surface buoy 1612, underwater gear 1614 and a buoy line 1616 connecting surface buoy 1612 with underwater gear 1614. Underwater gear 1614 may comprise one or more gillnets, lobster trawls, quahog traps, clam, crab and oyster traps or sleds, fishing weirs, and long line fishery equipment. However, underwater gear 1614 is not limited to fishing gear, but can also include any submerged equipment, device or system where entanglement by marine mammals is a potential problem. Underwater gear 1614 may include water column obstructions as well. Surface buoy 1612 may include any floating device used to indicate the location of underwater gear 1614. Surface buoy 1612 is connected to underwater gear 1614 via buoy line 1616 which comprises a rope, cable, etc. made of natural or synthetic material such as nylon, polyester, polypropylene, or other plastic or suitable material known in the art. In addition, rope or cable 1616 is attached to surface buoy 1612 and/or underwater gear 1614 by any means known in the art. As illustrated in FIG. 16, surface buoy 1612 floats at the water surface level, designated as 1613, while underwater gear 1614 is positioned e.g. on the sea bed, designated as 1615.

Fishing line 1610 further comprises at least one breakaway connector in accordance with the present invention. Fishing line 1610 may include one or more breakaway connectors of various configurations at various locations along fishing line 1610. For example, a first breakaway connector can be placed in buoy line 1616 at a location in the water column near surface buoy 1612. Additionally or alternatively, a second breakaway connector can be placed in buoy line 1616 at a location near underwater gear 1614 on sea bed 1615. Additionally or alternatively, a third breakaway connector can be placed in the middle of buoy line 1616, at a location between surface buoy 1612 and underwater gear 1614. Each of the first, second and third breakaway connectors has a weakened portion being configured to fail under stress.

In fishing line 1610, a load or stress is created in buoy line 1616, when e.g. a whale becomes entangled in buoy line 1616 or underwater gear 1614 and attempts to leave and/or release itself. When the load or stress is applied to the weakened portion of the first, second or third breakaway connector, which is configured to fail at a specific load smaller than the load or stress caused by the whale, the weakened portion will rupture to disconnect surface buoy 1612 from underwater gear 1614 thereby releasing the whale. It has been noted that due to many factors such as the depth of the sea where underwater gear 1614 is placed, the length of buoy line 1616, the location of the breakaway connector or links in buoy line 1616, the location in fishing line 1610 where the whale is entangled, and external influence of wave and wind etc., the load or stress caused by the whale's movement may occur at various angles. It is therefore important to configure the breakaway connector so that, in most cases, the stress caused by the whale's movement will always be applied to the weakened portion, thereby ensuring reliable rupture of the breakaway connector. In addition, it is also important that the breakaway connector is configured so as to allow a rope or cable to be attached thereto without using a noose or a closed loop which might be caught in the mouth of the whale after the breakaway connector breaks.

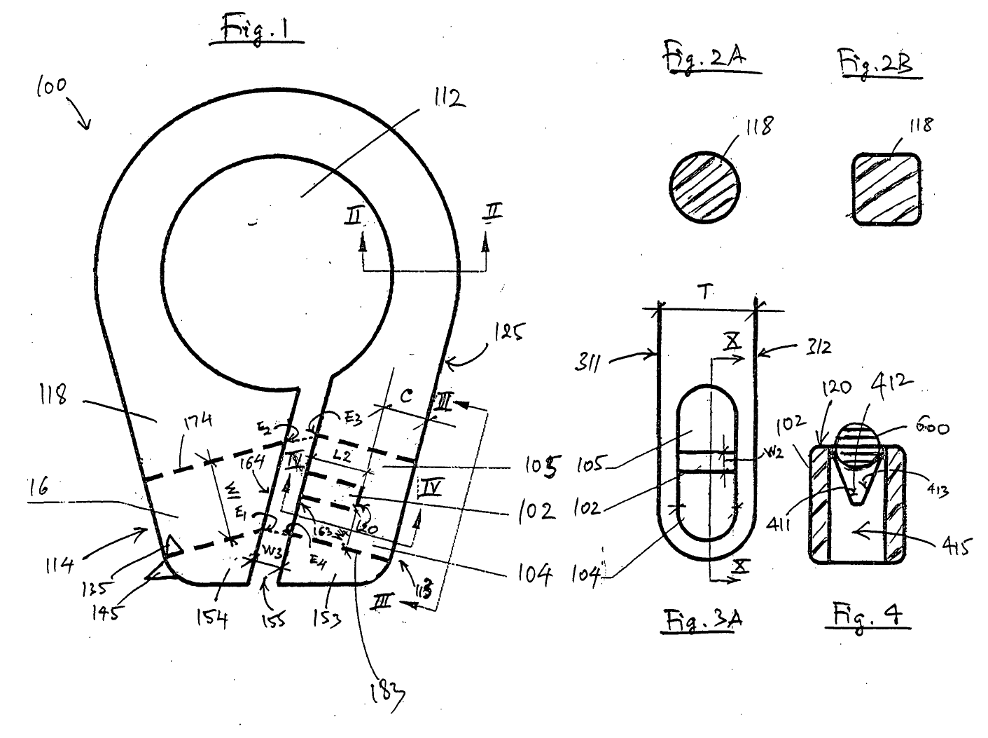

Such a configuration of the breakaway connector is shown in FIG. 1 which is a front view of a breakaway connector 100 in accordance with an embodiment of the present invention. Breakaway connector 100 comprises first connecting means or element for connecting with an external device, such as a surface buoy, and a second connecting means or element for connecting with another external device, such as underwater gear, using a length of rope. In particular, second connecting element is arranged to hold the rope in a bent state at a breakaway element that will fail under a load of a predetermined level to completely release the rope.

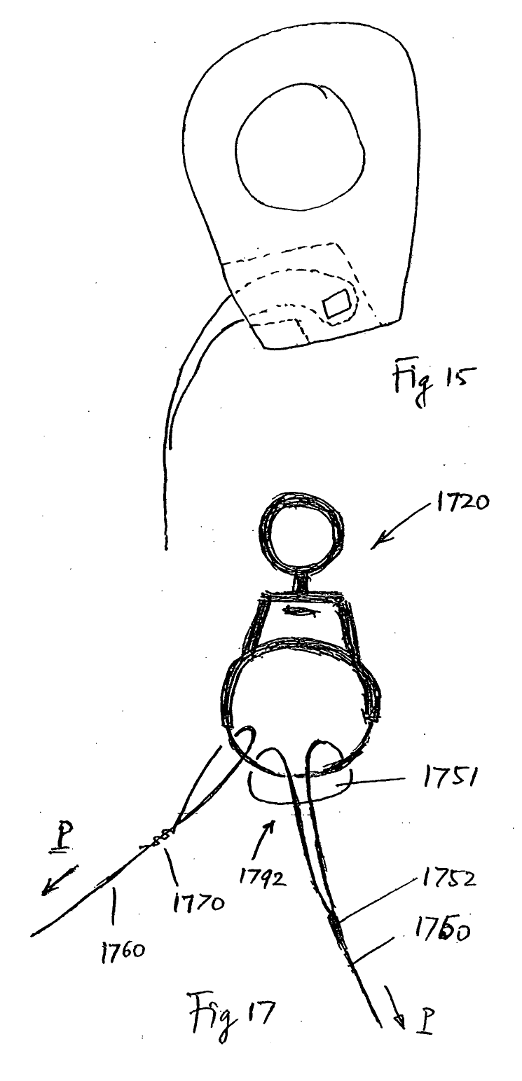

In FIG. 1, breakaway connector 100 includes a body 118 which defines an eye 112 which can be attached to a loop formed at one end of a rope of cable with the other end of the rope or cable being attached to the surface buoy or underwater gear in a known manner. However, other arrangements are not excluded as will be described herein below with reference to FIGS. 12-13. Eye 112, therefore, functions as the first connecting element.

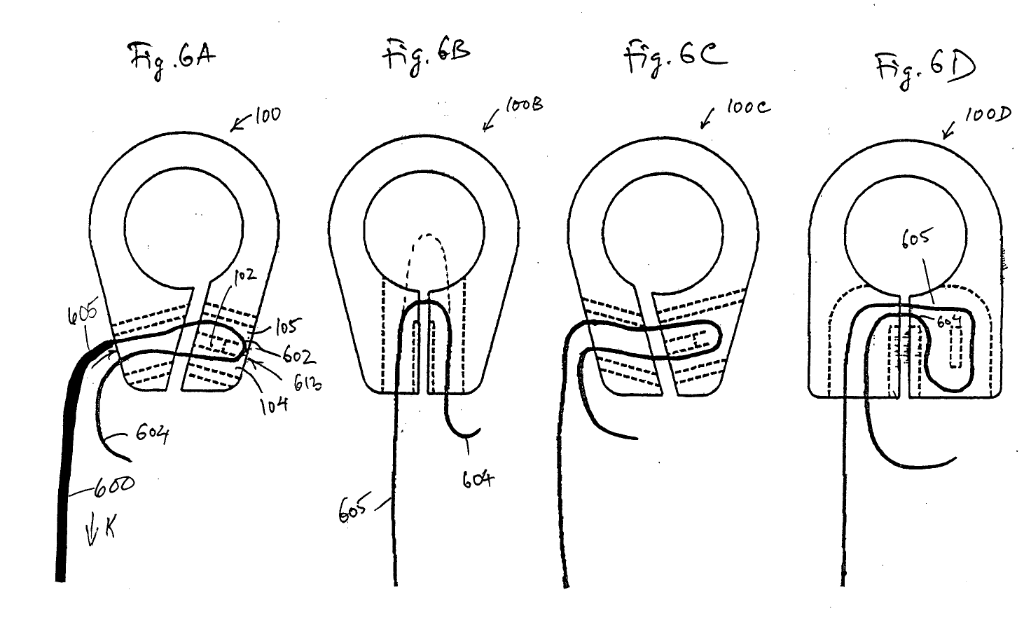

The second connecting element includes a through hole 116 extending through body 118 of breakaway connector 100, and a breakaway element or web 102 extending transversely of through hole 116 and dividing through hole 116 into a first channel or bore 104 and a second channel or bore 105 on opposite sides of web 102. Thus, the second connecting element defines a passage that guides a length of rope around web 102. As can be seen in FIG. 6A, rope 600 is received within the passage with a first section 604 of the rope being accommodated in first bore 104, and a second section 605 of the rope being accommodated in second bore 105. A bent section 602 of the rope, that connects first section 604 and second section 605, will come to rest on web 102 when one of first section 604 and second section 605 is pulled, e.g., in the direction of arrow K. When a marine mammal is entangled in the fishing line, a load applied to the rope due to struggling movements of the marine mammal is always applied to web 102 via bent section 602 of the rope.

In accordance with the present invention, web 102 defines a weakened region of breakaway connector 100. The weakened region will break first when the load applied thereto, via bent section 602, reaches a predetermined level. For certain types of underwater gear, such as lobster trap, the breaking load of the weakened region is preferably from about 500 to about 600 lbs. For other types of underwater gear and/or application, other strengths may be needed. In general, the breaking load of the weakened region is preferably in a range of from about 100 to about 3780 lbs.

In an aspect of the present invention, web 102 is the weakest portion of breakaway connector 100. In other words, a material failure load of breakaway connector 100 is minimal at web 102. The term “material failure load” is understood as the magnitude of tensile load applied to the material which is sufficient to cause failure or rupture of the material at the point of load application.

A material failure load of web 102 is smaller than that of body 118. It should be noted that, in order to ensure reliable rupture of the weakened region, web 102 should have a material failure load smaller than about 70% of a material failure load of body 118. Preferably, the material failure load of web 102 is about 50-60% of the material failure load of body 118. If web 102 and body 118 are made of the same material, e.g., when web 102 is integrated with body 118, width W2 (FIG. 1) of web 102 should be smaller than thickness T (FIG. 3A) of body 118. If web 102 and body 118 are made of different materials, e.g., when web 102 is formed as a separate piece planted into through hole 116 of breakaway connector 100, width W2 of web 102 should be selected to ensure that the material failure load of web 102 is smaller than the material failure load of body 118. Thus, width W2 or the cross section of web 102 can be changed to achieve the desired break strength or material failure load. Likewise, length L2 (FIG. 1) of web 102 can be changed to achieve the desired break strength or material failure load. An excessive length of web 102 may result in a web 102 with a material failure load greater than or approximate to that of body 118, which is undesirable because breakaway connector 100 may break at unexpected locations or portions.

Through hole 116 includes first section 113 and second section 114 which are angled with respect to each other as shown in FIG. 1. The angle between first section 113 and second section 114 of through hole 116, the configuration, including size, shape and material, of web 102 will determine the breaking point or material failure load of the web. The angle between first section 113 and second section 114 of through hole 116 can be from 0 to 180 degrees or more, preferably in the range from about 30 to about 150 degrees.

Web 102 does not extend the full axial length of through hole 116. Preferably, a clearance C (FIG. 1) is left between a surface 120 of web 102 and an outer side face 125 of body 118 to sufficiently accommodate bent section 602 so that bent section 602 does not project beyond side face 125 of body 118. In this manner, bent section 602 is completely received in through hole 116, avoiding undesirable physical contact with external objects. Clearance C has about the same size as width W4 (FIG. 1) of first bore 104 or second bore 105.

In accordance with the present invention, friction between rope 600 and at least one of the inner wall of through hole 116 and web 102 should be sufficient to hold the rope against slipping within through hole 116 until the weakened region of breakaway connector 100 fails.

In an aspect of the present invention, web 102 is preferably positioned in only one of the sections of through hole 116, e.g., first section 113. Thus, first section 604 and second section 605 of the rope are free to contact each other in second section 114 of through hole 116, especially at an opening 614 of through hole 116. A portion of second section 605 of the rope located in the vicinity of opening 614 will press a corresponding portion of first section 604 of the rope against a wall of through hole 116, when second section 605 of the rope is pulled towards the underwater gear, thereby preventing first section 604 of the rope from slipping in through hole 116.

In another aspect of the present invention, materials of body 118, web 102 and rope 600 as well as sizes of first bore 104, second bore 105, second section 114 and rope 600 can be selected to achieve the desired holding friction. For example, rope 600, through hole 116 and web 102 can be produced with rough surfaces and/or from materials that exhibit high friction coefficients. Additionally or alternatively, the diameter of rope 600 may be selected to be approximate to width W4 of first bore 104 and/or second bore 105, and width W1 (FIG. 1) of second section 114 of through hole 116 may be selected to be approximate to the diameter of rope 600. Preferably, each of first bore 104 and second bore 105 is sized so as to be capable of accommodating only one section of rope 600 whereas second section 114 of through hole 116 is sized so as to be capable of accommodating at maximum two sections of rope 600. In the configuration of FIG. 1, width W1 of second section 114 is smaller than the sum (W2+2W4) of the widths of web 102 and first bore 104 and second bore 105. Thus, first section 604 and second section 605 of the rope are brought closely to each other in second section 114 of through hole 116, enhancing the friction force between the rope sections.

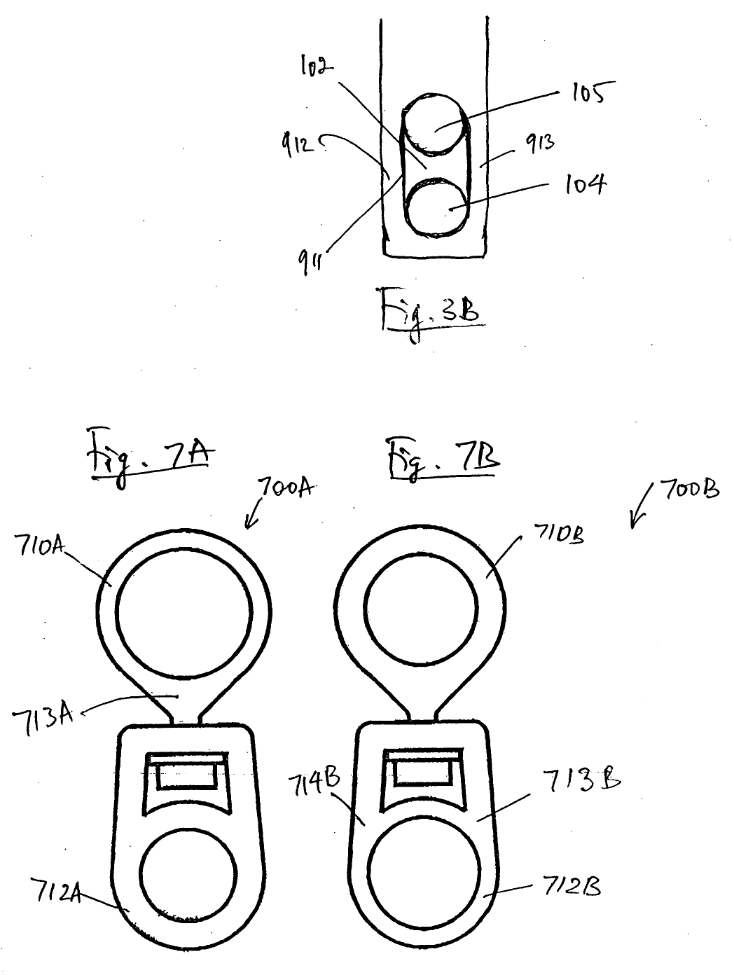

In a further aspect of the present invention, a projection 135 (FIG. 1) can be provide to locally reduce width W1 or W4 and to “clamp” rope 600 between internal walls of through hole 116. Although, projection 135 is depicted to be located at opening 614 (FIG. 6A) of through hole 116, similar projections may be provided at any locations on the inner wall of through hole 116 or on web 102. A disadvantage of this configuration is that it may be difficult to insert rope 600 through hole 116 as shown in FIGS. 6A-6D. This disadvantage may be overcome by forming a projection 145 outside through hole 116 as illustrated in FIG. 1. Although, projections 135, 145 may have any suitable configuration, it is desirable to round the edge of projections 135, 145 adapted to come into physical contact with rope 600 so that the rope may not be chaffed. For the same reason, the cross section of body 118 preferably has rounded edges or comers or configurations, at least in the region of eye 112, as shown in FIGS. 2A-2B.

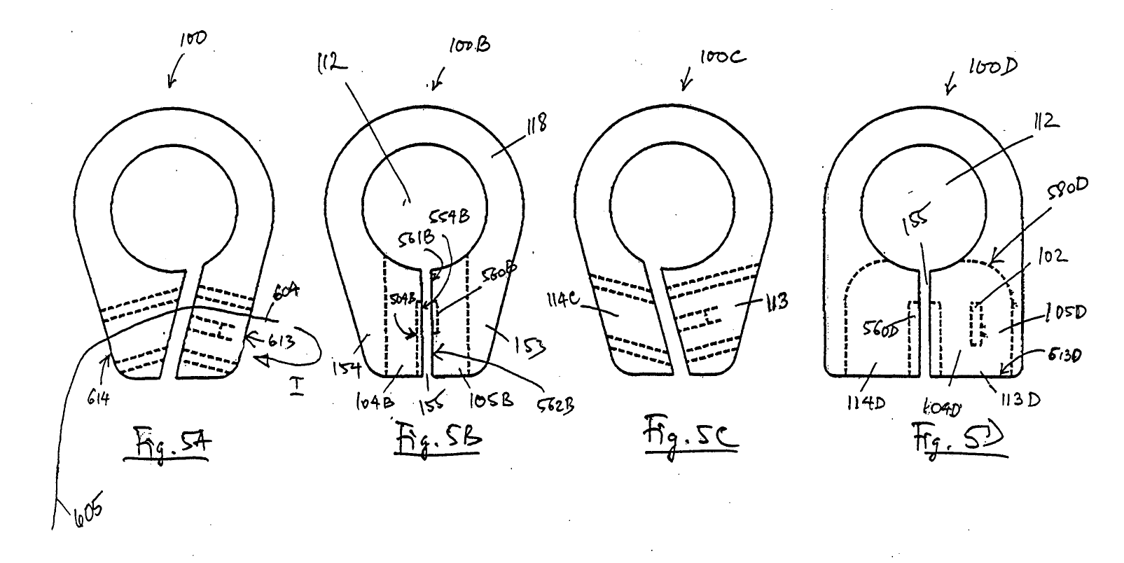

In yet another aspect of the present invention, surface 120 of web 102 may be notched, e.g., in the shape of an arcuate wedge. A more simple configuration is depicted in FIG. 4 with a notch 412 having straight side walls 411, 413. This notch tapers from surface 120 towards the opposite surface of web 102. At least a portion of bent section 602 of the rope is received in the notch as can be seen in FIG. 4. When either end of rope 600 is pulled, bent section 602 of the rope is drawn onto notch 412 and progressively squeezed by side walls 411, 413. The natural pinching action upon the rope between side walls 411, 413 prevents the rope from being pulled through hole 116. Thus, rope 600 is held in through hole 116 until the weakened region of breakaway connector 100 breaks.

Another advantage of the configuration depicted in FIG. 4 resides in that the weakened region is clearly defined by notch 412, ensuring reliable rupture of web 102. Web 102 is actually formed with a weakened or material reduced or “reduced-size” portion 415 below notch 412. Weakened portion 415 is now the weakest point of the whole breakaway connector 100, and will reliably break when the stress on the rope reaches the material failure load of the weakened portion. Other configurations of notch 412 are within the scope of the present invention. However, such configurations may not enjoy the benefit of the above described pinching action when notch 412 tapers as depicted in FIG. 4.

An alternative to weakened portion 415 is shown in FIG. 9. In the embodiment of FIG. 9, web 102 is attached or connected to opposite side walls 912, 913 of through hole 116 at connecting portions 911. At least one indentation 910 is formed in web 102 at a location near one of connecting portions 911. Indentation or indentations 910 define(s) weakened portion(s) 915 which is/are equivalent to weakened portion 415 of FIG. 4. Thus, when a sufficient load is applied to web 102 via bent section 602, the web will reliably break at weakened portion(s) 915, disconnecting web 102 from side walls 912, 913 of through hole 116, and allowing bent section 602 of the rope to slip through hole 116. Although, four indentations 910 are depicted in FIG. 9, any number of indentations can be formed in web 102. Additionally and alternatively, connecting portions 911 may be formed with a width smaller than width W2 of the middle portion of web 102.

Web 102 is preferably located in only one of first section 113 and second section 114 of through hole 116. However, it is within the scope of the present invention to provide web or webs 102 in both fist section 113 and second section 114 of through hole 116. First section 113 and second section 114 of through hole 116 may be contiguous as can be seen in FIG. 11, or may be formed in separate portions of breakaway connector 100 as can be seen in FIG. 1.

In FIG. 1, body 118 includes spaced first and second end portions 153, 154 in which first section 113 and second section 114 of through hole 116 are formed, respectively. First end portion 153 and second end portion 154 are separated by a slot 155. Peripheral edges of an opening 163 of first section 113 and a corresponding opening 164 of second section 114 are preferably aligned so as to facilitate insertion of rope 600 in through hole 116. That is, edge E3 of second bore 105 is located in a virtual extension from edge E2 of wall 174 of second section 114 as shown by phantom line in FIG. 1. Thus, rope 600 can be smoothly moved from second section 114 of through hole 116, across slot 155, into second bore 105 without being obstructed by edge E3. Likewise, edge E1 of second section 114 is located in a virtual extension from edge E4 of wall 183 of first bore 104, as shown by phantom line in FIG. 1, so that rope 600 can be smoothly returned from first bore 104, across slot 155, into second section 114 without being obstructed by edge E1. Openings 163, 164 may be slightly flared toward each other to facilitate insertion of rope 600.

Slot 155 is provided to facilitate attaching breakaway connector 100 to an external device, such as a surface buoy, by suitable means, e.g., a rope or cable tied up into a noose or a loop connector. Slot 155 may be sufficient wide to allow the noose or loop connector to directly pass through until it reaches eye 112. However, width W3 of slot 155 may be smaller than a diameter of the rope or the thickness of the loop connector's body. In this case, an operator will grasp, by hand or by tool, first end portion 153 and second end portion 154 of body 118, which has a degree of flexibility, and pull the end portions away from each other to widen slot 155. After the noose or loop connector has been passed through the widened slot and situated in eye 112, the end portions of body 118 are allowed to return to their normal positions, preventing the noose or loop connector from escaping eye 112. The attachment of the noose or loop connector to eye 112 is further secured when rope 600 is inserted into through hole 116 to cross slot 155, as can be seen in FIG. 6A. When second section 605 of rope 600 is pulled in direction K, first end portion 153 and second end portion 154 of body 118 may be brought into physical contact to close the gap (slot 155) therebetween.

Preferably, breakaway connector 100 is attached to a surface buoy using a swivel to minimize problems associated with twisting of rope 600 or the action of wind and waves. Such a swivel can be a conventional swivel formed without a breakaway feature. However, a breakaway swivel can be used together with the breakaway connector of the present invention to provide double protection.

FIGS. 7A and 7B show plan views of breakaway swivels that can be used in a fishing line, alone or in combination with breakaway connector 100. Breakaway swivel 700A in FIG. 7A has loop-shaped bodies 710A and 712A connected to each other by a connecting portion of the type described in U.S. patent application Ser. No. 10/042,378 which is incorporated herein by reference. In FIG. 7A, body 710A has a weakened portion with a thinner or reduced-size cross section while body 712A is a full-size loop with a thicker cross section. The term “reduced-size” means the weakened portion has at least one cross-sectional dimension smaller than that of the full-size loop and the connecting portion. Accordingly, the weakened portion is expected to be the weakest point of breakaway swivel 700A and will rupture first when an appropriate load or stress is applied to the breakaway swivel.

Additionally or alternatively, the weakened portion needs not necessarily have a reduced thickness or dimension with respect to other elements of breakaway swivel 700A. The weakened portion may have a thickness or dimension equal to or even greater than those of the remaining elements of breakaway swivel 700A, while remaining the weakest point in the breakaway swivel. It is sufficient to configure the weakened portion to have a material failure load smaller than those of the remaining elements, i.e. the full-size loop and the connecting portion. This can be done by selecting different materials, or configurations, or both, for the weakened loop and the remaining elements of the breakaway swivel. For example, body 710A may be entirely made of a material exhibiting a weaker mechanical strength than the remaining elements of breakaway swivel 700A.

An important feature of breakaway swivel 700A resides in the circumferential extent of the weakened portion. In particular, the weakened portion extends for almost 360 degrees, at least 270 degrees, circumferentially of body 710A. Body 710A includes a thick portion 713A to connect the weakened portion to the connecting portion of breakaway swivel 700A. Advantages of the elongated geometry of the weakened portion have been provided in the specification of U.S. patent application Ser. No. 10/042,378.

FIG. 7B is a reverse version of FIG. 7A with the upper body 710B being the full size loop and the lower body 712B including an elongated weakened portion. Body 712B includes two thick portions 713B and 714B to connect the weakened portion to the connecting portion of breakaway swivel 700B.

FIG. 3B shows a preferred embodiment of the present invention with first bore 104 and second bore 105 having substantially circular cross sections. The cross sections of first bore 104 and second bore 105 are of about the same size. Web 102 in this case has enlarged connecting portions 911 where web 102 is attached or connected to opposite side walls 912, 913 of through hole 116. This makes the central portion of web 102 the weakest point, unlike the embodiment shown in FIG. 9. Walls 912 and 913 in the vicinity of connecting portions 911 may fail before or together with failure of web 102. In either case, rope 600 will be released as though web 102 breaks alone.

FIG. 5A shows a breakaway connector similar to breakaway connector 100 of FIG. 1. FIG. 5A also demonstrates how rope 600 is attached to breakaway connector 100. Particularly, rope 600 has one end, in second section 605, being attached to underwater gear and the other end, in first section 604, which is a free end. The free end of rope 600 is first introduced into second section 114, passed across slot 155 and inserted into second bore 105, preferably without being obstructed by edge E3. Rope 600 is then bent around web 102 as indicated by arrow I in FIG. 5A. The free end of rope 600 is finally passed back through first bore 104 and second section 114, preferably without being obstructed by edge E1, to project beyond opening 614. Slightly pulling either sections of rope 600 brings bent section 602 to rest on web 102, as depicted in FIG. 6A. The free end of rope 600 may be left to dangle freely, as illustrated in FIG. 6A, without being positively connected or attached to an external object or second section 605.

In breakaway connector 100, it is important to attach rope 600 as described with respect to FIGS. 5A and 6A. If the free end of rope 600 is first inserted through first bore 104 and then returned via second bore 105, the rope may slip through hole 116 before the weakened region of breakaway connector 100 fails.

FIG. 5B shows another preferred embodiment of the breakaway connector of the present invention. FIG. 6B demonstrates how rope 600 is attached to the breakaway connector of FIG. 5B. Breakaway connector 100B in FIG. 5B has first bore 104B and second bore 105B on opposite sides of slot 155. A portion of second end portion 154, defined between a wall 504B of first bore 104B and a wall 554B of slot 155, and a similar portion in first end portion 153 together define a weakened portion that function as web 102 of breakaway connector 100. First bore 104B and second bore 105B preferably open into eye 112 so that the operator can pull the free end of rope 600 out of first bore 104B and pass back the free end through second bore 105B, as shown by phantom line in FIG. 6B. The weakened portion extends along slot 155 for a length that determines the desired material failure load of the weakened portion. As shown at 560B of FIG. 5B, second bore 105B and slot 155 communicate with each other in regions 561B, 562B.

FIG. 5C shows another preferred embodiment of the breakaway connector of the present invention. FIG. 6C demonstrates how rope 600 is attached to the breakaway connector of FIG. 5C. Breakaway connector 100C in FIG. 5C is similar to breakaway connector 100 of FIG. 1, except that the second section 114C is at a different angle with respect to first section 113. Rope 600 is preferably attached to breakaway connector 100C in the same manner described with reference to FIG. 6A.

FIG. 5D shows another preferred embodiment of the breakaway connector of the present invention. FIG. 6D demonstrates how rope 600 is attached to the breakaway connector of FIG. 5D. Breakaway connector 100D in FIG. 5D has first section 113D and second section 114D with web 102 positioned in first section 113D and dividing this section into first bore 104D and second bore 105D. The free end of rope 600 is first inserted through second section 114D. Wall section 580D is preferably curved so as to guide the free end of the rope into second bore 105D. The free end of the rope is then pulled from opening 613D of first section 113D and the rope is bent around web 102. Returning the free end of the rope to second section 114D may require first introducing the free end into eye 112 and then passing it back to second section 114D. When the rope is pulled, e.g., by a whale, second section 605 of rope 600 will press first section 604 against walls 560D that separates first section 113D and second section 114D from slot 155. As a result, rope 600 is effectively prevented from slipping inside breakaway connector 100D.

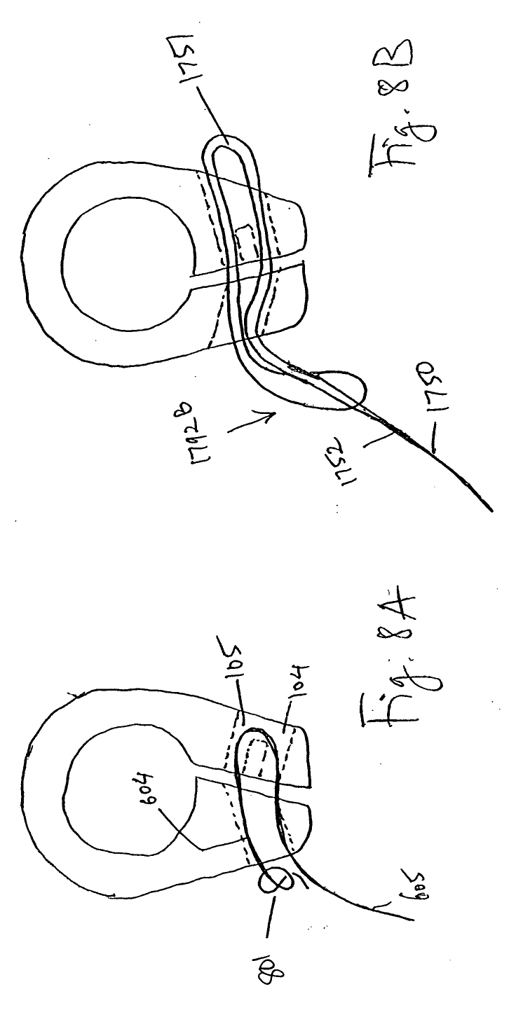

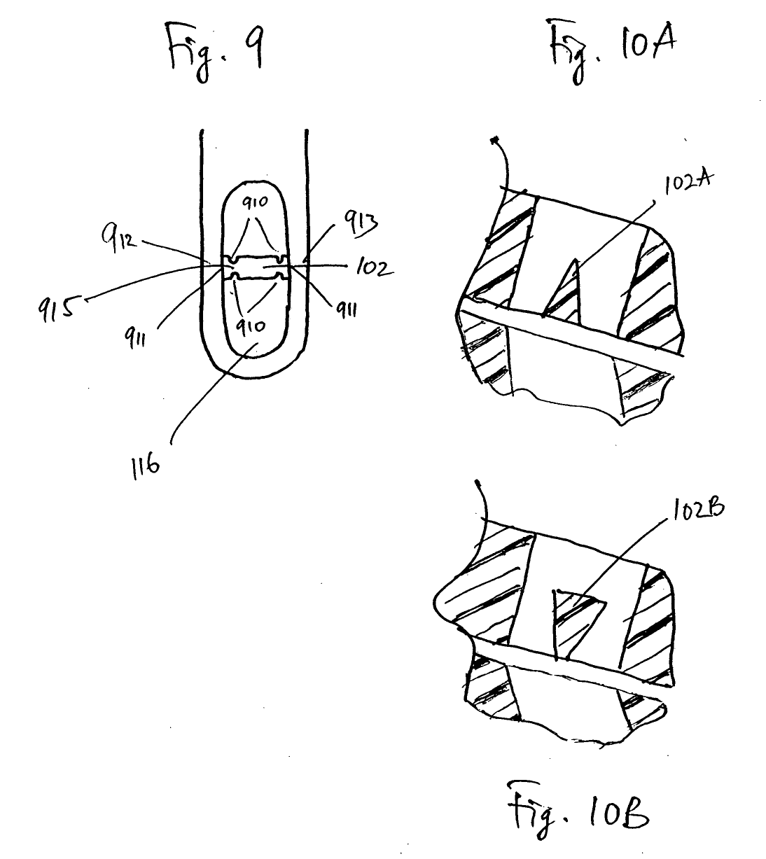

FIGS. 8A and 8B show alternative modes of attaching rope 600 to the breakaway connector of the present invention. Although, the breakaway connector of the present invention is configured to allow a rope to be attached thereto without using a noose or closed loop as depicted in FIG. 17, it is within the scope of the present invention to connect rope 1750 of FIG. 17 to breakaway connector 100 by forming a “hitch” as can be seen at 1792B in FIG. 8B. Of course, when this connection breaks, rope 1750 will be released with loop 1751 staying on an end thereof which is a disadvantage of the known connection because loop 1751 might be caught in the whale's mouth. However, the connection of FIG. 8B has an important advantage of the present invention that the load caused by the whale's movements will always be applied web 102 resulting in reliable rupture of the web.

In some applications, it may be permissible or even desirable to form or include a knot or an enlarged portion 801, e.g., at the free end of rope 600 as shown in FIG. 8A. Knot 801 is of a sufficient size that does not allow knot 801 to pass through hole 116. If knot 801 is formed, rope 600 can be attached to breakaway connector 100 in the reverse order, i.e., with the free end of rope 600 being first inserted through first bore 104 and then returned via second bore 105.

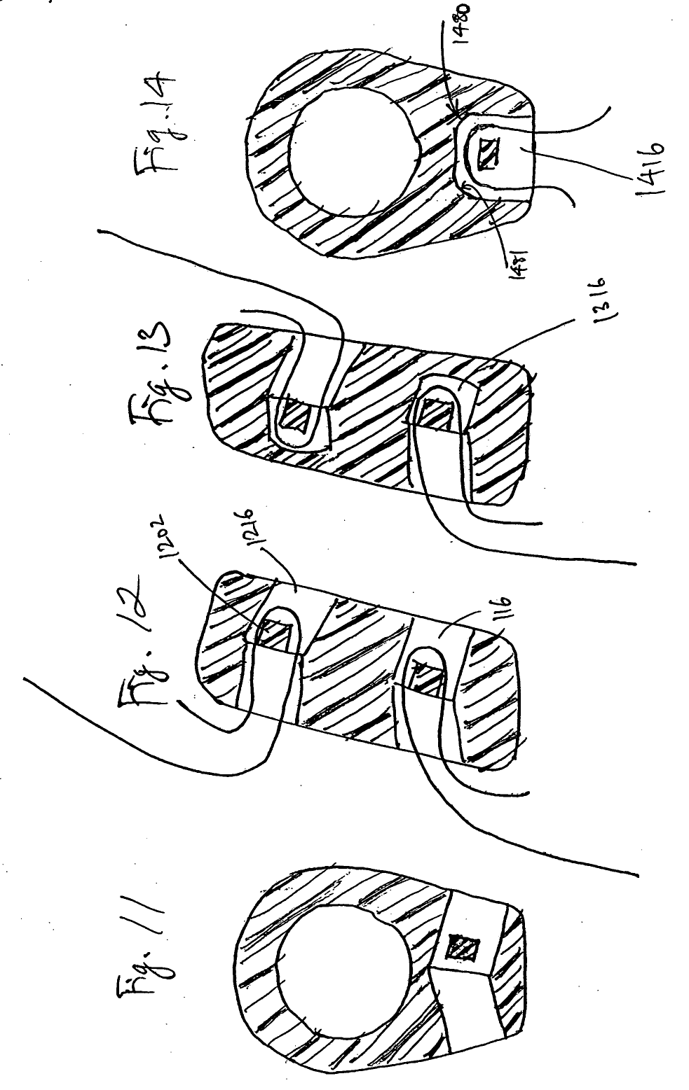

FIGS. 10A and 10B show different cross sections for web 102.

FIG. 11 shows another preferred embodiment of the breakaway connector of the present invention which is formed without slot 155.

FIG. 12 shows another preferred embodiment of the breakaway connector of the present invention which is formed without eye 112. The first connecting element in this case includes a passage 1216 similar to through hole 116. Transverse web 1202 in passage 1216 may or may not be breakable. If passage 1216 is used to attach the breakaway connector to a surface buoy and through hole 116 is used to attach the breakaway connector to underwater gear, the material failure load of web 1202 should be higher than web 102. The ropes may be attached to the breakaway connector from the same side, i.e., the left hand side in FIG. 12, or from opposite sides as depicted in FIG. 13.

FIG. 13 also shows another preferred embodiment of the breakaway connector of the present invention which is formed with a blind hole 1316. Passing a rope around the web in blind hole 1316 is more difficult than in the case of breakaway connector 100, and may require guiding inner wall sections similar to 580D in FIG. 5D.

FIG. 14 shows another preferred embodiment of the breakaway connector of the present invention which is formed with a blind hole 1416 similar to blind hole 1316. Again, guiding inner wall sections 1480, 1481 are required.

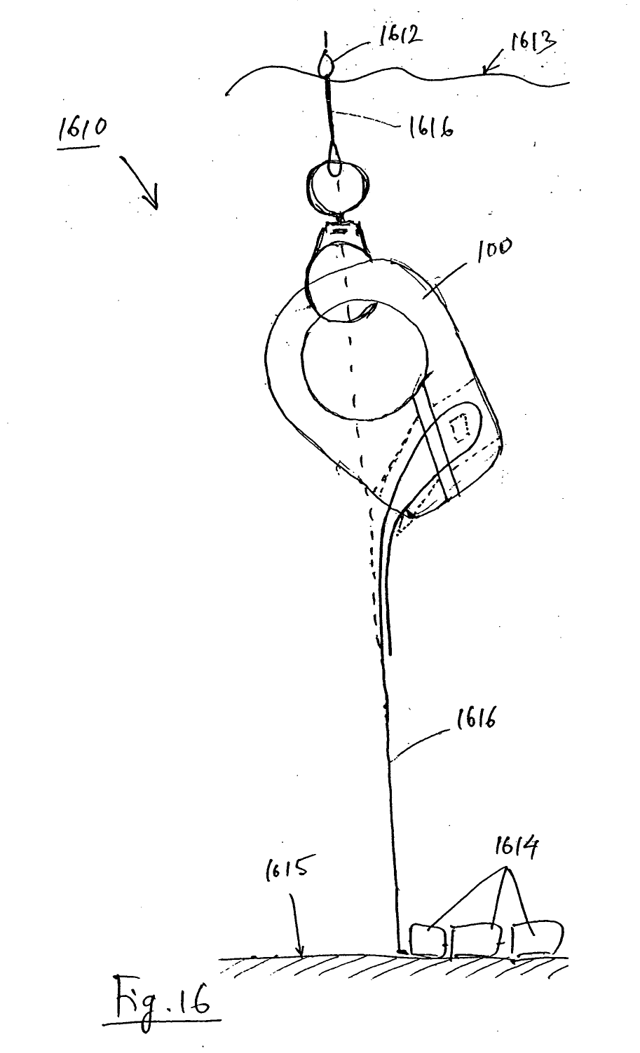

FIG. 15 shows another preferred embodiment of the breakaway connector of the present invention.

FIG. 16 depicts a fishing line in which the breakaway connector of the present invention is used. Breakaway connector 100 may be directly attached to rope 1616 or via a swivel, which could be breakable or not, as shown in FIG. 16.

The entirety of breakaway connector 100, or at least body 118, is preferably made by molding. Materials suitable for the breakaway connector of the present invention are described in the specification of U.S. patent application Ser. No. 10/042,378. The manufacturing process of the described breakaway connector is simple because the device includes no moveable element and, virtually, no assembly is required.

Web 102 can be made integral with body 118, e.g., by molding, or formed as a separated piece. In the latter case, one or both side walls 912, 913 has a hole, or preferably a through hole, to receive web 102. Web 102 can be simply inserted into the holes of side walls 912, 913 or can be fastened or otherwise secured to the side walls. The operator can remove web 102 from the side walls 912, 913 and replace the removed web with another web having similar or different properties, including material failure load. The replacement webs may have the same shape and size, but are made from different materials having different mechanical strengths. The replacement webs may be provided with similar or identical connecting portions 911 standardized for connection with the holes of side walls 912, 913, but preferably have different material failure loads in the middle portions thereof. Since, in most cases, the first connecting element or eye 112 remains attached to the surface buoy after web 102 breaks, it is necessary to replace only the web, rather than the whole device as it would be the case in, e.g., the swivel of FIGS. 7A-7B.

Web 102 can be made to be stronger than rope 600. In this case rope 600 is the weak link that will break first under sufficient stress. A weakened or thinner or reduce size region may be formed in rope 600, as described in U.S. Pat. No. 5,913, 670 which is incorporated by reference herein in its entirety. The weakened region of the rope is preferably located at web 200. Web 102 in this case preferably has the configuration shown in FIG. 10A.

In brief, the present invention provides a breakaway connector which always reliably breaks upon application of an appropriate load regardless of how e.g. under what angle the load occurs. The present invention also allows a rope or cable to be attached thereto without using or having to form a noose or closed loop at one end of the rope. The breakaway connector of the present invention is advantageously light weighted and inexpensive.

While there have been described and illustrated specific embodiments of the invention, it will be clear that variations in the details of the embodiments specifically illustrated and described may be made without departing from the true spirit and scope of the invention as defined in the appended claims.

What is claimed is:

1. A breakaway connector, comprising:
first connecting means for connecting with an external device; and
second connecting means for maintaining a length of rope in a bent state and for holding the rope until a load applied to the rope reaches a predetermined level at which said second connecting means completely release the rope, said second connecting means comprising a breakaway element that will fail under said load of said predetermined level to release the rope.

2. The breakaway connector of claim 1, wherein a material failure load of said breakaway element is from about 500 to about 600 lbs.

3. The breakaway connector of claim 1, wherein a material failure load of said connector is minimal at said breakaway element.

4. The breakaway connector of claim 1, wherein said second connecting means further comprise guiding means for guiding the rope around said breakaway element to define a bent section of the rope at said breakaway element and first and second sections of the rope on opposite sides of the bent section.

5. The breakaway connector of claim 4, wherein said guiding means comprise a passage and said breakaway element is positioned in said passage to divide said passage into first and second channels for accommodating the first and second sections of the rope, respectively.

6. A breakaway connector, comprising
a body having a through hole; and
a web extending transversely of said through hole and dividing said through hole into first and second channels;
wherein a material failure load of said web is smaller than a material failure load of said body.

7. The breakaway connector of claim 6, wherein said web is an integral part of said body and does not extend for a full axial extent of said through hole.

8. The breakaway connector of claim 6, wherein said web has a notch extending axially of said through hole, said notch being positioned in a central region of said web for accommodating, at least partially, a bent section of a rope being inserted in the first and second channels to pass around said web.

9. The breakaway connector of claim 6, wherein said web connects opposite inner walls of said through hole, said web having indentations located adjacent to said opposite inner walls.

10. The breakaway connector of claim 6, wherein said through hole includes, in an axial direction thereof, first and second sections angled with respect to each other, said web being positioned within said first section.

11. The breakaway connector of claim 10, wherein the angle between said first and second sections is from about 30 to about 60 degrees.

12. The breakaway connector of claim 6, wherein said body defines an eye for connection to an external device.

13. The breakaway connector of claim 6, wherein
said body is a ring-shaped body that extends circumferentially for less than 360 degrees and has first and second end portions circumferentially spaced from each other;
said ring-shaped body defines a loop for connection to an external device; and
a spacing between said spaced first and second end portions defines a slot extending from an outer circumferential surface of said body into said loop.

14. The breakaway connector of claim 13, wherein said through hole includes first and second sections formed in said first and second end portions, respectively, said web being positioned within one of said first and second sections of said through hole.

15. The breakaway connector of claim 14, wherein said first and second sections of said through hole are at least partially aligned.

16. The breakaway connector of claim 15, wherein said first and second sections of said through hole are straight sections that are angled with respect to each other.

17. The breakaway connector of claim 14, wherein said first and second sections of said through hole extend transversely of said slot without directly opening into said loop.

18. The breakaway connector of claim 14, wherein said first and second sections of said through hole directly open onto said loop and said slot.

19. The breakaway connector of claim 13, wherein said through hole comprises first and second sections extending generally in parallel with said slot and directly opening onto said loop, said web being defined by a wall that separates one of said first and second sections of the through hole from said slot.

20. A breakaway connection, comprising a rope and a breakaway connector, wherein
said breakaway connector comprises a body having a passage for the rope and a transverse web positioned in said passage;
a length of said rope being received in said passage includes first and second sections on opposite sides of said web and a bent section which connects said first and second sections and comes to rest on said web when one of the first and second sections of said rope is pulled; and
said web defines a weakened region of said breakaway connector which will fail to completely release the rope from said breakaway connector when a load applied to said web via said bent section of said rope reaches a predetermined level.

21. The connection of claim 20, wherein friction between the first and second sections of said rope and at least one of said passage and said web is sufficient to hold said rope against slipping within said passage until said weakened region fails.

22. The connection of claim 20, wherein said rope includes a weakened portion which has a material failure load smaller than that of the weakened region of said breakaway connector, so that said rope breaks before said weakened region.

23. The connection of claim 22, wherein said bent section of said rope includes said weakened portion.

24. The connection of claim 20, wherein said passage includes
a first section in which said web is positioned and which is divided by said web into two channels each accommodating one of said first and second sections of said rope; and
a second section free of said web so that said first and second sections of said rope are allowed to physically contact each other in said second section of said passage.

25. The connection of claim 24, wherein inner walls of said first and second sections of said passage are aligned to facilitate insertion of said rope between said first and second sections of said passage.

26. The connection of claim 20, further comprising underwater gear connected to an end portion of said first section of said rope, an end portion of said second section of said rope being left free without being tied up into a knot or a noose, so that said end portion of said second section of said rope can pass through said passage to release said rope from said breakaway connector.

27. The connection of claim 20, further comprising underwater gear connected to an end portion of said first section of said rope, an end portion of said second section of said rope being tied up into a knot which must be untied before said end portion of said second section of said rope can pass through said passage to release said rope from said breakaway connector.

28. The connection of claim 20, further comprising underwater gear connected to an end portion of said first section of said rope,
wherein, when said first section of said rope is pulled towards the underwater gear, said first section of said rope presses said second section of said rope against a wall of said breakaway connector, thereby preventing the second section of said rope from slipping within said passage.

29. The connection of claim 20, further comprising a swivel, said body further comprising a connecting portion connected with said swivel.

30. The connection of claim 20, wherein
said body is a ring-shaped body that extends circumferentially for less than 360 degrees and has first and second end portions normally circumferentially spaced from each other;
said ring-shaped body defines a loop for connection to an external member;
a spacing between said spaced first and second end portions is increasable, by virtue of a flexibility of said body, to facilitate movement of a wall of the external member through said spacing before the rope is attached to said breakaway connector; and
said rope being attached to said breakaway connector crosses said spacing and prevents the external member from being disconnected from said loop.

31. The connection of claim 30, further comprising said external member which includes a swivel.

32. A method of establishing a breakaway connection in a fishing line, comprising the steps of:
connecting one end of a rope to underwater gear; and
attaching an opposite end of said rope to a breakaway connector without using or having to form a noose or a closed loop in the opposite end of said rope.

33. The method of claim 32, wherein said attaching comprises
inserting the opposite end of said rope through a passage of said breakaway connector, on one side of a breakaway element disposed in said passage, said breakaway element defining a weakened region of said breakaway connector which will fail to completely release the rope from said breakaway connector when a load applied to said breakaway element via said rope reaches a predetermined level; and
passing back the opposite end of said rope through said passage, on an opposite side of the breakaway element.
